(19) United States
(12) Patent Application Publication
(10) Pub. No.: US 2020/0154103 A1
(43) Pub. Date: May 14, 2020

(54) IMAGE PROCESSING METHOD ON BASIS OF INTRA PREDICTION MODE AND APPARATUS THEREFOR

(71) Applicant: LG Electronics Inc., Seoul (KR)

(72) Inventors: Jin HEO, Seoul (KR); Ling LI, Seoul (KR)

(21) Appl. No.: 16/628,608

(22) PCT Filed: Jul. 4, 2018
(86) PCT No.: PCT/KR2018/007585

§ 371 Date: Jan. 3, 2020

Related U.S. Application Data
(60) Provisional application No. 62/528,444, filed on Jul. 4, 2017.

(51) Int. Cl. H04N 19/11; H04N 19/105; H04N 19/176; H04N 19/59

(52) U.S. Cl. CPC H04N 19/11; H04N 19/59; H04N 19/176; H04N 19/105

(57) ABSTRACT

Disclosed herein are an intra prediction mode based image processing method and an apparatus therefor. Specifically, a method for processing an image based on an intra prediction mode may include: deriving an intra prediction mode of a current block; generating a bottom right reference sample adjacent to a bottom right side of the current block; generating a right reference sample or a lower reference sample by using the bottom right reference sample generating a first prediction sample and a second prediction sample of the current sample in the current block based on a prediction direction of the intra prediction mode; and generating a final prediction sample of the current sample by interpolating the first prediction sample and the second prediction sample.

### TECHNICAL FIELD

The present disclosure relates to a still image or moving image processing method and, more particularly, to a method of encoding/decoding a still image or moving image based on an intra-prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

An object of the present disclosure is to propose a linear interpolation intra prediction method for generating a prediction sample to which a weight is applied based on a distance between a prediction sample and a reference sample.

Furthermore, an object of the present disclosure is to propose a method for more accurately generating a bottom right reference sample used for linear interpolation intra prediction.

Furthermore, an object of the present disclosure is to propose a method for generating a bottom right reference sample used for linear interpolation intra prediction by considering prediction directivity of an intra prediction mode.

Furthermore, an object of the present disclosure is to propose a method for performing linear interpolation intra prediction by using a bottom right reference sample value of an original image.

Furthermore, an object of the present disclosure is to propose a method for effectively signaling a bottom right reference sample value of an original image from an encoder to a decoder.

The objects of the present disclosure are not limited to the technical objects described above, and other technical that are objects not mentioned herein may be understood to those skilled in the art from the description below.

### Technical Solution

In an aspect of the present disclosure, a method for processing an image based on an intra prediction mode may include: deriving an intra prediction mode of a current block; generating a bottom right reference sample adjacent to a bottom right side of the current block; generating a right reference sample or a lower reference sample by using the bottom right reference sample generating a first prediction sample and a second prediction sample of the current sample in the current block based on a prediction direction of the intra prediction mode; and generating a final prediction sample of the current sample by interpolating the first prediction sample and the second prediction sample.

Preferably, the bottom right reference sample may be generated by using a reference sample determined according to the prediction direction of the intra prediction mode.

Preferably, if the prediction direction of the intra prediction mode belongs to a predetermined region, the bottom right reference sample may be generated by using a reference sample determined according to the prediction direction.

Preferably, the bottom right reference sample may be generated by using a reference sample determined according to the prediction direction and at least one reconstructed reference sample adjacent to the current block.

Preferably, the at least one reconstructed reference sample may be determined as a reference sample most adjacent in horizontal or vertical direction of the bottom right reference sample, or a bottom leftmost reference sample or a top rightmost reference sample among reference samples other than reference sample direction determined according to the prediction direction.

Preferably, the bottom right reference sample may be generated by adding a sample value of bottom right location of an encoded block before the current block and a difference value of the bottom right reference sample received from an encoder.

Preferably, the bottom right reference sample may be generated by adding a prediction sample value of the bottom right sample in the current block generated based on the intra prediction mode and a difference value of the bottom right reference sample received from the encoder.

Preferably, the bottom right reference sample may be generated by using a quantized representative value received from the encoder.

In another aspect of the present disclosure, an apparatus for processing an image based on an intra prediction mode may include: a prediction mode derivation unit for deriving an intra prediction mode of a current block; a bottom right reference sample generation unit for generating a bottom right reference sample adjacent to a bottom right side of the current block; a reference sample array generation unit for generating a right reference sample or a lower reference sample by using the bottom right reference sample; a temporary prediction sample generation unit for generating a first prediction sample and a second prediction sample of a current sample in the current block based on prediction direction of the intra prediction mode and a final prediction sample generation unit for generating a final prediction sample of the current sample by interpolating the first prediction sample and the second prediction sample.

### Advantageous Effects

According to an embodiment of the present disclosure, accuracy of prediction can be enhanced by linearly interpolating a plurality of reference samples based on an intra prediction mode.

Further, according to an embodiment of the present disclosure, a bottom right reference sample is more accurately generated to increase accuracy of prediction and further enhance overall compression performance.

The technical effects of the present disclosure are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present disclosure, provide embodiments of the present disclosure, and describe the technical features of the present disclosure with the description below.

FIG. 1 is an embodiment to which the present disclosure is applied, and shows a schematic block diagram of an encoder in which the encoding of a still image or moving image signal is performed.

FIG. 2 is an embodiment to which the present disclosure is applied, and shows a schematic block diagram of a decoder in which the encoding of a still image or moving image signal is performed.

FIG. 3 is a diagram for illustrating the split structure of a coding unit to which the present disclosure may be applied.

FIG. 4 is a diagram for illustrating a prediction unit to which the present disclosure may be applied.

FIG. 5 is an embodiment to which the present disclosure is applied and is a diagram illustrating an intra-prediction method.

FIG. 6 illustrates prediction directions according to intra-prediction modes.

FIGS. 7 and 8 are diagrams for describing a linear interpolation prediction method as an embodiment to which the present disclosure is applied.

FIG. 9 is a diagram for describing a method for generating a bottom right reference sample in a linear interpolation prediction method in the related art as an embodiment to which the present disclosure may be applied.

FIG. 10 is a diagram for describing a method for generating right reference samples and bottom reference samples as an embodiment to which the present disclosure is applied.

FIG. 11 is a diagram illustrating a method for generating a bottom right reference sample according to an embodiment of the present disclosure.

FIG. 12 is a diagram for describing a method for adaptively generating a bottom right reference sample according to an intra prediction direction as an embodiment to which the present disclosure is applied.

FIG. 13 is a diagram illustrating a method for generating a bottom right reference sample according to an embodiment of the present disclosure.

FIG. 14 is a diagram illustrating a method for generating a bottom right reference sample according to an embodiment of the present disclosure.

FIG. 15 is a diagram illustrating a method for transmitting a sample value of a bottom right reference sample location of an original image according to an embodiment of the present disclosure.

FIG. 16 is a diagram illustrating a method for transmitting a sample value of a bottom right reference sample location of an original image according to an embodiment of the present disclosure.

FIGS. 17 and 18 are diagrams illustrating a method for transmitting a sample value of a bottom right reference sample location of an original image according to an embodiment of the present disclosure.

FIG. 19 is a diagram illustrating a linear interpolation prediction method based on an intra prediction mode according to an embodiment of the present disclosure.

FIG. 20 is a diagram more specifically illustrating an intra prediction unit according to an embodiment of the present disclosure.

FIG. 21 is a structural diagram of a content streaming system as an embodiment to which the present disclosure is applied.

### MODE FOR INVENTION

Hereinafter, preferred embodiments of the present disclosure will be described by reference to the accompanying drawings. The description that will be described below with the accompanying drawings is to describe exemplary embodiments of the present disclosure, and is not intended to describe the only embodiment in which the present disclosure may be implemented. The description below includes particular details in order to provide perfect understanding of the present disclosure. However, it is understood that the present disclosure may be embodied without the particular details to those skilled in the art.

In some cases, in order to prevent the technical concept of the present disclosure from being unclear, structures or devices which are publicly known may be omitted, or may be depicted as a block diagram centering on the core functions of the structures or the devices.

Further, although general terms widely used currently are selected as the terms in the present disclosure as much as possible, a term that is arbitrarily selected by the applicant is used in a specific case. Since the meaning of the term will be clearly described in the corresponding part of the description in such a case, it is understood that the present disclosure will not be simply interpreted by the terms only used in the description of the present disclosure, but the meaning of the terms should be figured out.

Specific terminologies used in the description below may be provided to help the understanding of the present disclosure. Furthermore, the specific terminology may be modified into other forms within the scope of the technical concept of the present disclosure. For example, a signal, data, a sample, a picture, a frame, a block, etc may be properly replaced and interpreted in each coding process.

Hereinafter, in the present disclosure, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the present disclosure is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in the present disclosure, a pixel or pixel element is collected referred to as a sample. Furthermore, using a sample may mean using a pixel value or a pixel element value.

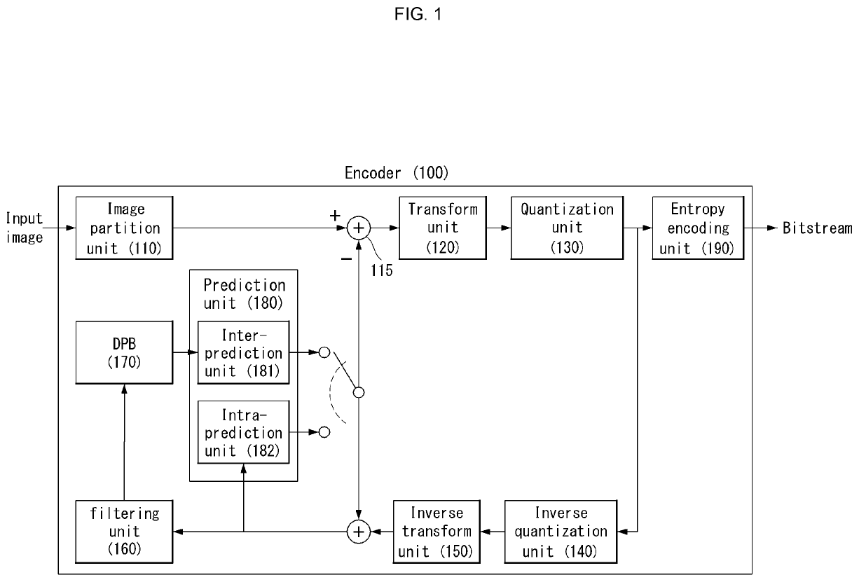

FIG. 1 is an embodiment to which the present disclosure is applied, and shows a schematic block diagram of an encoder in which the encoding of a still image or moving image signal is performed.

Referring to FIG. 1, an encoder 100 may include a picture split unit 110, a subtraction unit 115, a transform unit 120, a quantization unit 130, a dequantization (inverse-quantization) unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter-prediction unit 181 or intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transformation to the quantized signal through the dequantization unit 140 and the inverse transform unit 150, the residual signal may be reconstructed. By adding the reconstructed residual signal to the prediction signal that is outputted from the inter-prediction unit 181 or the intra-prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter-prediction unit 181. As such, by using the filtered picture as a reference picture in an inter-picture prediction mode, the encoding rate as well as the image quality may be improved.

The decoded picture buffer 170 may store the filtered picture in order to use it as a reference picture in the inter-prediction unit 181.

The inter-prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter-prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter-prediction unit 181 may perform prediction by generating an interpolation pixel by applying the interpolation filter to the integer pixel, and by using the interpolated block that includes interpolated pixels as a prediction block.

The intra-prediction unit 182 predicts the current block by referring to the samples adjacent the block that is to be encoded currently. The intra-prediction unit 182 may perform the following procedure in order to perform the intra-prediction. First, the intra-prediction unit 182 may prepare a reference sample that is required for generating a prediction signal. Furthermore, the intra-prediction unit 182 may generate a prediction signal by using the reference sample prepared. After, the intra-prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra-prediction.

In particular, the intra-prediction unit 182 according to the present disclosure may perform intra-prediction on a current block by linearly interpolating prediction sample values generated based on the intra-prediction mode of the current block. The intra-prediction unit 182 is described in more detail later.

The prediction signal (or prediction block) generated through the inter-prediction unit 181 or the intra-prediction unit 182 may be used to generate a reconstructed signal (or reconstructed block) or may be used to generate a residual signal (or residual block).

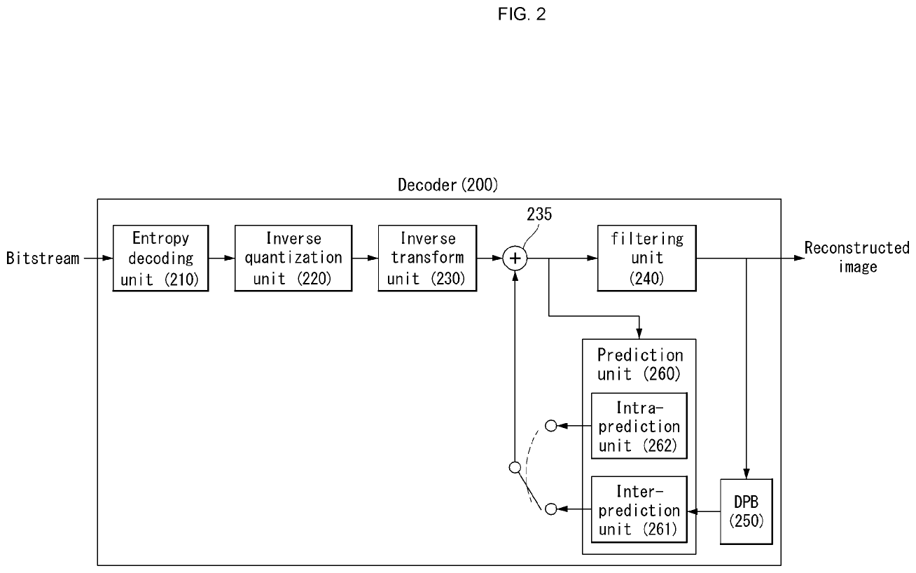

FIG. 2 is an embodiment to which the present disclosure is applied, and shows a schematic block diagram of a decoder in which the encoding of a still image or moving image signal is performed.

Referring to FIG. 2, a decoder 200 may include an entropy decoding unit 210, a dequantization unit 220, an inverse transform unit 230, an addition unit 235, a filtering unit 240, a decoded picture buffer (DPB) 250 and a prediction unit 260. Furthermore, the prediction unit 260 may include an inter-prediction unit 261 and an intra-prediction unit 262.

Furthermore, the reconstructed video signal outputted through the decoder 200 may be played through a play-back device.

The decoder 200 receives the signal (i.e., bit stream) outputted from the encoder 100 shown in FIG. 1, and the entropy decoding unit 210 performs an entropy decoding operation of the received signal.

The dequantization unit 220 acquires a transform coefficient from the entropy-decoded signal using quantization step size information.

The inverse transform unit 230 obtains a residual signal (or residual block) by inversely transforming transform coefficients using an inverse transform scheme.

The adder 235 adds the obtained residual signal (or residual block) to the prediction signal (or prediction block) output by the prediction unit 260 (i.e., inter-prediction unit 261 or intra-prediction unit 262), thereby generating a reconstructed signal (or reconstructed block).

The filtering unit 240 applies filtering to the reconstructed signal (or reconstructed block) and outputs it to a playback device or transmits it to the decoding picture buffer unit 250. The filtered signal transmitted to the decoding picture buffer unit 250 may be used as a reference picture in the inter-prediction unit 261.

In the present disclosure, the embodiments described in the filtering unit 160, the inter-prediction unit 181 and the intra-prediction unit 182 of the encoder 100 may also be applied to the filtering unit 240, the inter-prediction unit 261 and the intra-prediction unit 262 of the decoder, respectively, in the same way.

In particular, the intra-prediction unit 262 according to the present disclosure may perform intra-prediction on a current block by linearly interpolating prediction sample values generated based on an intra-prediction mode of the current block. The intra-prediction unit 262 is described in detail later.

In general, the block-based image compression method is used in a technique (e.g., HEVC) for compressing a still image or a moving image. A block-based image compression method is a method of processing a video by splitting the video into specific block units, and may decrease the capacity of memory and a computational load.

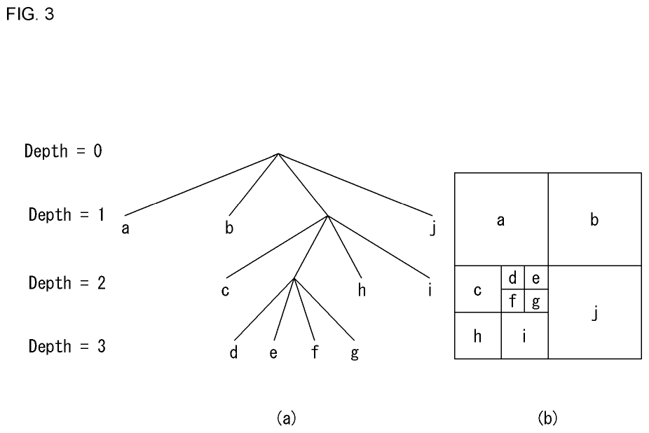

FIG. 3 is a diagram for illustrating the split structure of a coding unit that may be applied to the present disclosure.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, bottom nodes of a depth 1 (depth=1) are generated. Furthermore, a node (i.e., a leaf node) no longer split from the bottom node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, bottom nodes of a depth 2 (i.e., depth=2) are generated. Furthermore, a node (i.e., leaf node) no longer split from the bottom node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, bottom nodes having a depth of 3 (i.e., depth=3) are generated. Furthermore, a node (i.e., leaf node) no longer split from the bottom node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra-prediction or the inter-prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra-prediction and the inter-prediction are not used together for the PUs that belong to a single CU, and the PUs that belong to a single CU are coded by the same prediction method (i.e., intra-prediction or the inter-prediction).

The PU is not split in the Quad-tree structure, but is split once in a single CU in a predetermined form. This will be described by reference to the drawing below.

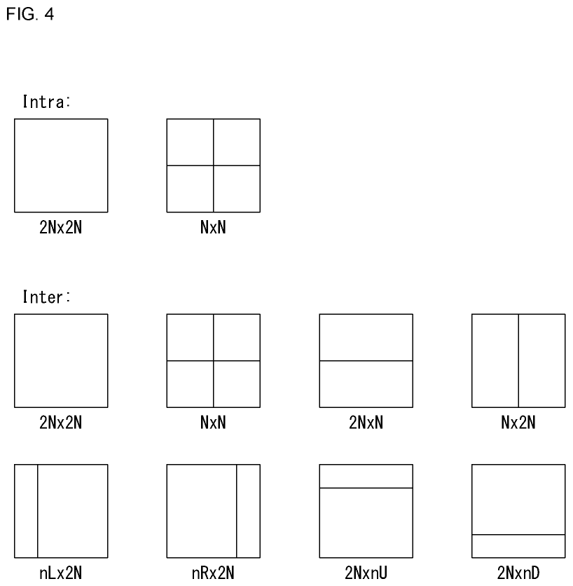

FIG. 4 is a diagram for illustrating a prediction unit that may be applied to the present disclosure.

A PU is differently split depending on whether the intra-prediction mode is used or the inter-prediction mode is used as the coding mode of the CU to which the PU belongs.

FIG. 4(a) illustrates a PU of the case where the intra-prediction mode is used, and FIG. 4(b) illustrates a PU of the case where the inter-prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra-prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter-prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra-prediction, transformation/quantization, dequantization/inverse transformation and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra-prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TU(j) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag ‘0’, the corresponding TU is no longer split.

Prediction

In order to reconstruct a current processing unit on which decoding is performed, the decoded part of a current picture including the current processing unit or other pictures may be used.

A picture (slice) using only a current picture for reconstruction, that is, performing only intra-prediction, may be referred to as an intra-picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra-prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter-prediction means a method of predicting the pixel value of the current processing block with reference to reconstructed regions within another reconstructed picture other than a current picture.

Hereinafter, intra-prediction is described in more detail.

Intra-Prediction

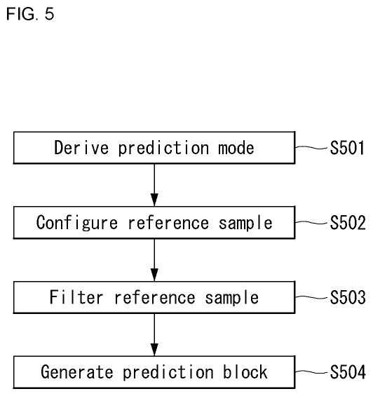

FIG. 5 is an embodiment to which the present disclosure is applied and is a diagram illustrating an intra-prediction method.

Referring to FIG. 5, the decoder derives an intra-prediction mode of a current processing block (S501).

In intra-prediction, there may be a prediction direction for the location of a reference sample used for prediction depending on a prediction mode. An intra-prediction mode having a prediction direction is referred to as intra-angular prediction mode “Intra_Angular prediction mode.” In contrast, an intra-prediction mode not having a prediction direction includes an intra-planar (INTRA_PLANAR) prediction mode and an intra-DC (INTRA_DC) prediction mode.

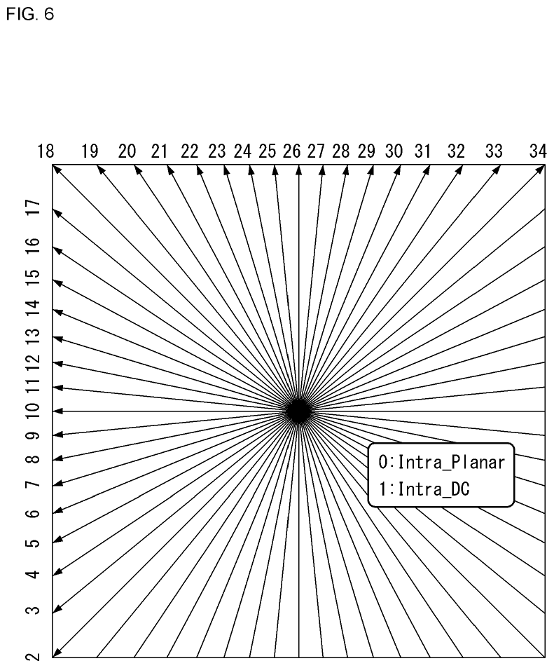

Table 1 illustrates intra-prediction modes and associated names, and FIG. 6 illustrates prediction directions according to intra-prediction modes.

TABLE 1

| Intra prediction mode | associated names |
|---|---|
| 0 | INTRA_PLANAR |
| 1 | INTRA_DC |
| 2 ... 34 | INTRA_ANGULAR2 ... INTRA_ANGULAR34 |

In intra-prediction, prediction may be on a current processing block based on a derived prediction mode. A reference sample used for prediction and a detailed prediction method are different depending on a prediction mode. Accordingly, if a current block is encoded in an intra-prediction mode, the decoder derives the prediction mode of a current block in order to perform prediction.

The decoder checks whether neighboring samples of the current processing block may be used for prediction and configures reference samples to be used for prediction (S502).

In intra-prediction, neighboring samples of a current processing block mean a sample neighboring the left boundary of the current processing block of an nS×nS size, a total of 2×nS samples neighboring the left bottom of the current processing block, a sample neighboring the top boundary of the current processing block, a total of 2×nS samples neighboring the top right of the current processing block, and one sample neighboring the top left of the current processing block.

However, some of the neighboring samples of the current processing block have not yet been decoded or may not be available. In this case, the decoder may configure reference samples to be used for prediction by substituting unavailable samples with available samples.

The decoder may perform the filtering of the reference samples based on the intra-prediction mode (S503).

Whether the filtering of the reference samples will be performed may be determined based on the size of the current processing block. Furthermore, a method of filtering the reference samples may be determined by a filtering flag transferred by the encoder.

The decoder generates a prediction block for the current processing block based on the intra-prediction mode and the reference samples (S504). That is, the decoder generates the prediction block for the current processing block (i.e., generates a prediction sample) based on the intra-prediction mode derived in the intra-prediction mode derivation step S501 and the reference samples obtained through the reference sample configuration step S502 and the reference sample filtering step S503.

If the current processing block has been encoded in the INTRA_DC mode, in order to minimize the discontinuity of the boundary between processing blocks, at step S504, the left boundary sample of the prediction block (i.e., a sample within the prediction block neighboring the left boundary) and the top boundary sample (i.e., a sample within the prediction block neighboring the top boundary) may be filter.

Furthermore, at step S504, in the vertical mode and horizontal mode of the intra-angular prediction modes, as in the INTRA_DC mode, filtering may be applied to the left boundary sample or the top boundary sample.

This is described in more detail. If the current processing block has been encoded in the vertical mode or the horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for prediction may be much closer than the distance from the reference sample used for prediction.

Accordingly, the decoder may adaptively apply filtering on left boundary samples or top boundary samples depending on whether an intra-prediction direction is a vertical direction or a horizontal direction. That is, the decoder may apply filtering on the left boundary samples if the intra-prediction direction is the vertical direction, and may apply filtering on the top boundary samples if the intra-prediction direction is the horizontal direction.

As described above, in HEVC, 33 directivity prediction methods, two non-directivity prediction methods, that is, a total of 35 prediction methods are used through intra prediction and a prediction sample is generated by using a neighborhood reference sample (when it is assumed that the neighborhood reference sample is encoded/decoded in a raster scan order, an top reference sample or a left reference sample). In addition, the generated prediction sample is copied according to the directivity of the intra prediction mode.

Since a prediction sample value is just copied according to a prediction direction, there is a problem occurs in that accuracy of prediction deteriorates as a distance from the reference sample increases. That is, when distances between the reference samples and the prediction sample used for prediction decrease, the prediction accuracy is high, but when the distances between the reference samples and the prediction sample used for prediction increase, the prediction accuracy is low.

In order to reduce prediction errors, the present disclosure proposes a linear interpolation intra prediction method for generating a prediction sample to which a weight is applied based on a distance between a prediction sample and a reference sample. In particular, the present disclosure proposes a method for more accurately generating a bottom right reference sample as compared with the method for generating the bottom right reference sample in the linear interpolation prediction method which is recently discussed. First, the linear interpolation prediction method will be described with reference to the following drawings.

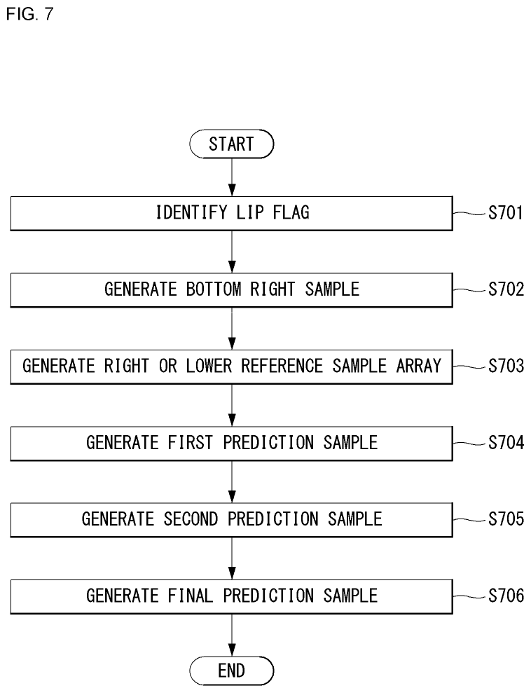

FIGS. 7 and 8 are diagrams for describing a linear interpolation prediction method as an embodiment to which the present disclosure is applied.

Referring to FIG. 7, the decoder is mainly described for convenience of description, but the linear interpolation prediction method proposed in the present disclosure may be equally performed even in the encoder.

The decoder parses (or confirms) an LIP flag indicating whether linear intra prediction (LIP) (or linear interpolation intra prediction) is applied to a current block from a bitstream received from the encoder (S701).

In an embodiment, the decoder may derive an intra prediction mode of the current block before step S701 and derive the intra prediction mode of the current block after step S701. In other words, before or after step S701, a step of deriving the intra prediction mode may be added. In addition, the step of deriving the intra prediction mode may include parsing an MPM flag indicating whether a most probable mode (MPM) is applied to the current block and parsing an index indicating a prediction mode applied to the intra prediction of the current block in an MPM candidate or residual prediction mode candidate according to whether the MPM is applied.

The decoder generates a bottom right reference sample adjacent to a bottom right side of the current block (S702). The decoder may generate the bottom right reference sample by using various methods. The detailed description thereof will be made later.

The decoder generates a right reference sample array or a bottom reference sample array by using a reconstructed reference sample around the current block and the bottom right reference sample generated in step S702 (S703). In the present disclosure, the right reference sample array may be collectively referred to as the right reference sample, a right reference sample, a right reference sample array, etc., and a bottom reference sample array may be collectively referred to as a bottom reference sample, a bottom reference sample, a bottom reference sample array, etc. The detailed description thereof will be made later.

The decoder generates a first prediction sample and a second prediction sample based on the prediction direction of the intra prediction mode of the current block (S704 and S705). Here, the first prediction sample and the second prediction sample mutually represent reference samples positioned at an opposite side to the current block based on the prediction direction. The first prediction sample (may be referred to as a first reference sample) represents a prediction sample generated by using the reference sample determined according to the intra prediction mode of the current block among reconstructed reference samples (left, top left, and top reference samples) according to the intra prediction in the related art as described in FIGS. 5 and 6 above. In addition, the second prediction sample (may be referred to as a second reference sample) represents a prediction sample generated by using the reference sample determined according to the intra prediction mode of the current block in the right reference sample array or the bottom reference sample array in step S703.

The decoder interpolates (or linearly interpolates) the first prediction sample and the second prediction sample generated in step S704 and S705 to generate a final prediction sample (S706). The decoder weighted-sums the first prediction sample and the second prediction sample based on the distances between the current sample and the prediction samples (or reference sample) to generate the final prediction sample.

Referring to FIG. 8, the decoder is mainly described for convenience of description, but the linear interpolation prediction method proposed in the present disclosure may be equally performed even in the encoder.

The decoder may generate a first prediction sample P based on the intra prediction mode. Specifically, the decoder may derive the first prediction sample by interpolating (or linearly interpolating) reference sample A and reference sample B determined according to the prediction direction among the top reference samples. Meanwhile, unlike in FIG. 8, when the reference sample determined according to the prediction direction is positioned at an integer pixel location, inter-reference sample interpolation may not be performed.

Further, the decoder may generate a second prediction sample P′ based on the intra prediction mode. Specifically, the decoder determines reference sample A′ and reference sample B′ according to the prediction direction of the intra prediction mode of the current block among the bottom reference samples and linearly interpolates reference sample A′ and reference sample B′ to derive the second prediction sample. Meanwhile, unlike in FIG. 8, when the reference sample determined according to the prediction direction is positioned at the integer pixel location, the inter-reference sample interpolation may not be performed.

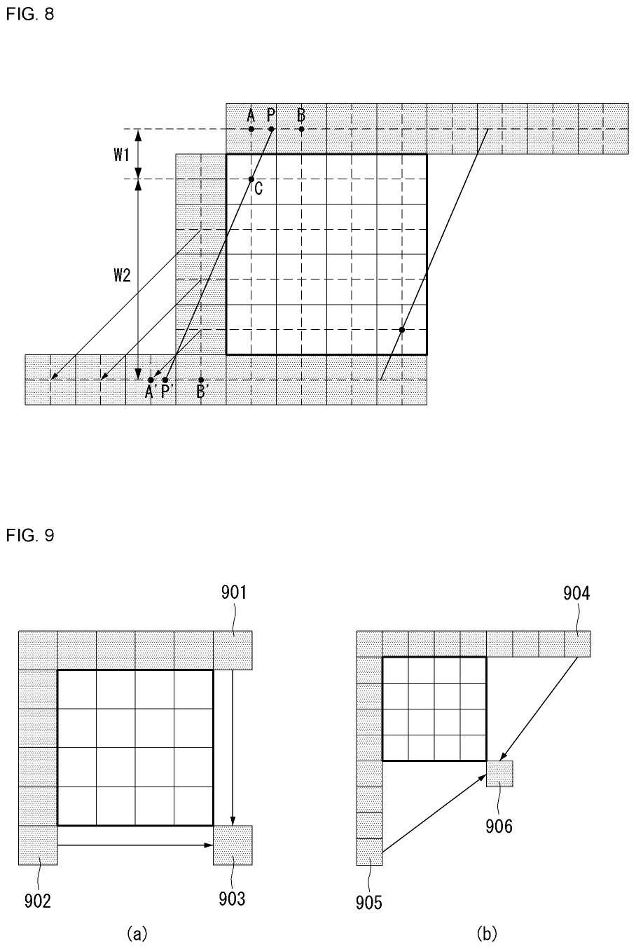

FIG. 9 is a diagram for describing a method for generating a bottom right reference sample in a linear interpolation prediction method in the related art as an embodiment to which the present disclosure may be applied.

Referring to FIG. 9, the encoder/decoder may generate a bottom right reference sample 903 adjacent to a bottom right side of the current block by using a top right reference sample 901 adjacent a top right side of the current block and a bottom left reference sample 902 adjacent to a bottom left side of the current block.

Referring to FIG. 9(b), the encoder/decoder may generate a bottom right reference sample 906 by using a sample 904 (hereinafter, referred to as a top rightmost sample) (e.g., a sample apart from the top left reference sample of the current block by a distance which is two times larger than a width of the current block in a horizontal direction, i.e., [2*n−1, −1] sample in an n×n block) positioned at a rightmost side among the reference samples neighboring to the top right side of the current block and a sample 905 (hereinafter, referred to as a bottom leftmost sample) (e.g., a sample apart from the top left reference sample of the current block by a distance which is two times larger than a height of the current block in a vertical direction, i.e., [−1, 2*n−1] sample in the n×n block) positioned at a leftmost side among the reference samples neighboring to the bottom left side of the current block.

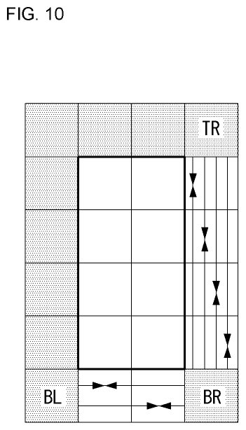

FIG. 10 is a diagram for describing a method for generating right reference samples and bottom reference samples as an embodiment to which the present disclosure is applied.

Referring to FIG. 10, the method is described by assuming a case where the size of the current block is 2×4. The encoder/decoder may generate the right reference sample and/or the bottom reference sample by using the bottom right reference sample BR adjacent to the bottom right side of the current block and the reconstructed reference sample around the current block.

Specifically, the encoder/decoder may generate the bottom reference sample by linearly interpolating the bottom right reference sample (BR) and a reference sample (bottom left (BL)) adjacent to the bottom left side of the current block. In other words, the encoder/decoder may generate the bottom reference samples by performing weighted-sum in units of pixel according to a distance ratio for each of the bottom right reference sample (BL) and the bottom left reference sample (BL).

Further, the encoder/decoder may generate the right reference sample by linearly interpolating the bottom right reference sample (BR) and a reference sample (top right (TR)) adjacent to the top right side of the current block. In other words, the encoder/decoder may generate the bottom reference samples by performing weighted-sum in units of pixel according to a distance ratio for each of the bottom right reference sample (BR) and the top right reference sample (BL).

As described above, in the linear interpolation prediction method, the encoder/decoder may generate the prediction block by performing weighted-sum depending on a distance between a reconstructed top reference sample (or left reference sample) which is previously encoded/decoded and a predicted (or derived) bottom reference sample (or right reference sample) which is not yet encoded/decoded. That is, both a reference sample of a reconstructed area and a reference sample of an area which is not reconstructed are used for linear interpolation intra prediction.

That is, in the linear interpolation intra prediction method, accuracy of prediction depends on how accurately the reference sample of the area which is not reconstructed is generated. That is, in the linear interpolation intra prediction method, compression efficiency depends on how accurately the right reference sample or the bottom reference sample is generated and to this end, it is very important to increase the accuracy of the bottom right reference sample.

Accordingly, the present disclosure proposes a method for more accurately generating a right bottom reference sample used for linear interpolation intra prediction. That is, in the present disclosure, the accuracy of the bottom right reference sample is increased to more accurately derive (or predict) the reference samples of the area which is not yet encoded/decoded.

### Embodiment 1

In an embodiment of the present disclosure, the encoder/decoder may generate the bottom right reference sample based on the prediction direction of the intra prediction mode. In other words, the encoder/decoder may generate the bottom right reference sample by using the reference sample determined according to the prediction direction of the intra prediction mode among reference samples of a surrounding reconstructed area.

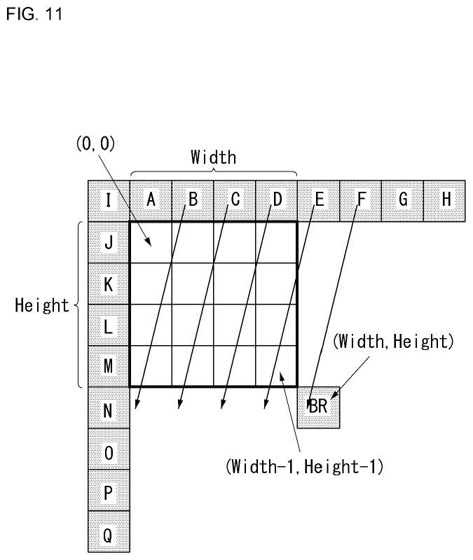

FIG. 11 is a diagram illustrating a method for generating a bottom right reference sample according to an embodiment of the present disclosure.

Referring to FIG. 11, it is assumed that the prediction direction of the intra prediction mode of the current block is an arrow direction (i.e., a positive vertical direction). A case where the prediction mode having the corresponding prediction directivity for intra prediction of the current block is selected in an optimal mode means that a possibility that the prediction block generated according to the selected prediction directivity will be most similar to an original block is high. Accordingly, there is a high possibility that the reference sample determined according to the prediction direction from the bottom right reference sample among neighboring reference samples of the previously reconstructed area will be most similar to a sample at a corresponding location of the bottom right reference sample in the original image.

Accordingly, the encoder/decoder may generate the bottom right reference sample by using the prediction direction of the intra prediction mode. In the example of FIG. 11, a bottom right reference sample value may be determined as a sample value of a reference sample F among top neighboring reference samples.

In FIG. 11, it is assumed that the reference sample determined according to the prediction direction is at the integer pixel location in order to generate the bottom right reference sample, but the present disclosure is not limited thereto and when the reference sample determined according to the prediction direction is at a fractional pixel location in order to generate the bottom right reference sample, the bottom right reference sample may be generated by interpolating two neighboring reference samples.

The encoder/decoder may generate the sample value of the bottom right reference sample according to the prediction direction of the prediction mode similarly to the method for generating the prediction sample in the existing intra prediction. When a coordinate of the top left sample of the current block is (0,0), the bottom right reference sample may be at a (Width, Height) location. Here, width represents the width of the current block and height represents the height of the current block. The encoder/decoder may generate the bottom right reference sample with the sample value of the reference sample determined according to the (Width, Height) location and the prediction direction of the prediction mode.

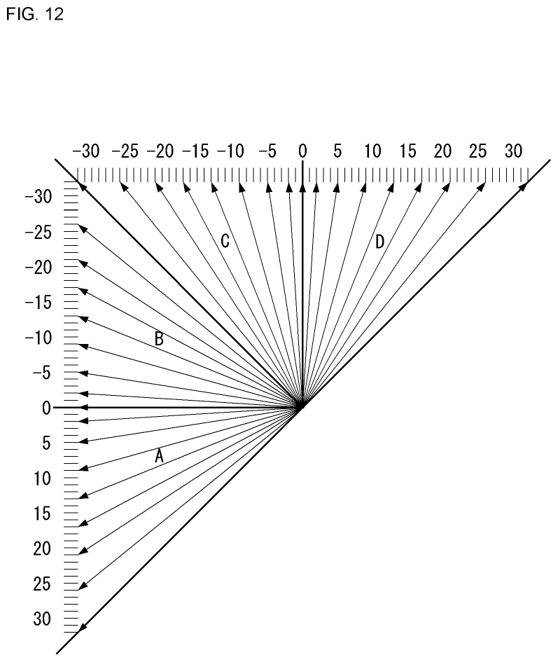

FIG. 12 is a diagram for describing a method for adaptively generating a bottom right reference sample according to an intra prediction direction as an embodiment to which the present disclosure is applied.

In an embodiment of the present disclosure, the encoder/decoder may apply the method for generating the bottom right reference sample considering the prediction directivity proposed by considering various conditions.

Referring to FIG. 12, the prediction direction of the intra prediction mode may be divided into four areas A, B, C, and D according to the directivity. Areas A and B indicate horizontal directivity and areas C and D indicate vertical directivity. In the horizontal directivity, area A shows positive directivity and area B shows negative directivity. Further, in the vertical directivity, area C shows the negative directivity and area D shows the positive directivity.

The encoder/decoder may variably apply the method for generating the bottom right reference sample proposed by considering the prediction directivity. As one example, the encoder/decoder may generate the bottom right reference sample by applying the method described in FIG. 11 above when the prediction direction of the current block belongs to area B or C having the negative directivity and generate the bottom right reference sample by applying the method described in FIG. 9 above when the prediction mode of the current block belongs to area A or D having the positive directivity.

As another example, the encoder/decoder may generate the bottom right reference sample by applying the method described in FIG. 9 above when the prediction direction of the current block belongs to area B or C having the negative directivity and generate the bottom right reference sample by applying the method described in FIG. 11 above when the prediction mode of the current block belongs to area A or D having the positive directivity.

Hereinabove, the method for generating the bottom right reference sample by using one reference sample (an interpolated reference sample in the case of a fractional pixel) determined according to the prediction direction is described. In another embodiment, the encoder/decoder may generate the bottom right reference sample by additionally using the neighboring reference sample in addition to the reference sample determined according to the prediction direction. The method will be described with reference to following drawing.

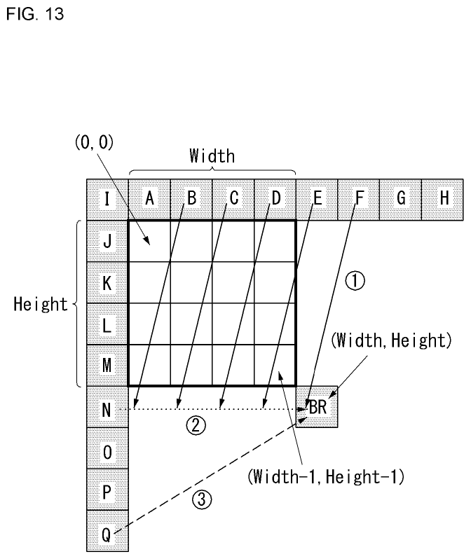

FIG. 13 is a diagram illustrating a bottom right reference sample generating method according to an embodiment of the present disclosure.

Referring to FIG. 13, it is assumed that the prediction mode of the current block is a vertical directivity mode. The encoder/decoder may generate the bottom right reference sample by using the reference sample determined according to the prediction direction and a surrounding reference sample. The surrounding reference sample used in this case may be a direction other than the reference sample determined according to the prediction direction. That is, when the prediction mode of the current block is the vertical directivity mode, the encoder/decoder may generate the top reference sample and at least one left reference sample determined according to the prediction direction.

For example, when the prediction direction of the current block is the vertical directivity mode, the encoder/decoder may determine the top reference sample (i.e., top reference sample F, \textcircled{1}) according to the prediction directivity as in the method described in FIG. 11 above and determine the left reference sample as horizontal left reference sample N (\textcircled{2}) and/or bottom leftmost reference sample Q (\textcircled{3}). Thereafter, the encoder/decoder may generate the bottom right reference sample by performing weighted-sum of the determined reference samples. Equation 1 below shows an equation using a value of left reference sample N and Equation 2 below shows an equation using a value of most bottom left sample Q.

BR=(Width*F+Height*N+(Width+Height)/2)/(Width+Height) [Equation 1]

BR=(Width*F+Height*Q+(Width+Height)/2)/(Width+Height) [Equation 2]

Unlike the example of FIG. 13, even when the prediction direction of the current block is the horizontal directivity mode, the encoder/decoder may determine a bottom right reference sample value by the same method. That is, when the prediction direction is the horizontal directivity, the left reference sample may be determined according to the prediction direction similarly to the methods described in FIGS. 11 and 13 above and the top reference sample may be determined as top reference sample E positioned in the vertical direction of the bottom right reference sample or reference sample H positioned on a top rightmost end at present. In addition, the bottom right reference sample may be generated by weighted-sum according to Equation 1 or 2 described above.

Further, in an embodiment, the encoder/decoder may generate the bottom right reference sample by using the sample value of the reference sample determined according to the prediction direction and an average value of opposite reference samples (i.e., reference samples in directions other than the reference sample direction determined according to the prediction direction).

For example, the encoder/decoder may generate the bottom right reference sample by using the average value of left reference sample N and bottom leftmost reference sample Q most adjacent in the horizontal direction of the bottom right reference sample among the opposite reference samples and the sample value of top reference sample F determined according to the prediction direction. Alternatively, for example, the encoder/decoder may generate the bottom right reference sample by using the average value of reference samples N, O, P, and Q (i.e., reference samples from the left reference sample to the most bottom left reference sample most adjacent in the horizontal direction) and the sample value of top reference sample F.

### Embodiment 2

In an embodiment of the present disclosure, the encoder/decoder may perform linear interpolation intra prediction by using the bottom right reference sample value of the original image.

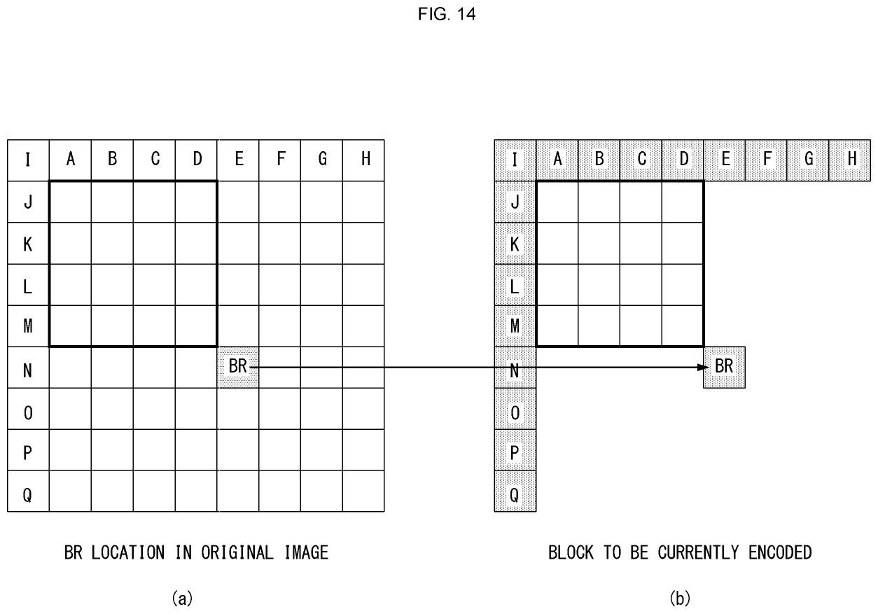

FIG. 14 is a diagram illustrating a method for generating a bottom right reference sample according to an embodiment of the present disclosure.

Referring to FIG. 14, the encoder/decoder may generate the bottom right reference sample by using the sample value of the bottom right reference sample location of the current block of the original image. That is, the encoder/decoder may find a sample at a location which is the same as the bottom right reference sample location of a block to be currently encoded/decoded in the original image and copy the found sample to the bottom right reference sample value of the block to be currently encoded/decoded and use the corresponding sample for the linear interpolation intra prediction.

In this case, since the sample value of the original image may not be immediately used in the decoder, signaling of the bottom right reference sample value is required. In the embodiment of the present disclosure, for effective signaling, the encoder may i) transmit to the decoder a difference value between the bottom right reference sample value of an intra block which is previously encoded and the bottom right reference sample value of the original image, ii) transmit to the decoder the difference value between the bottom right prediction sample value and the bottom right reference sample value of the original image, and iii) transmit a quantized representative value to the decoder. Hereinafter, the method will be described in detail in each embodiment.

### Embodiment 2-1

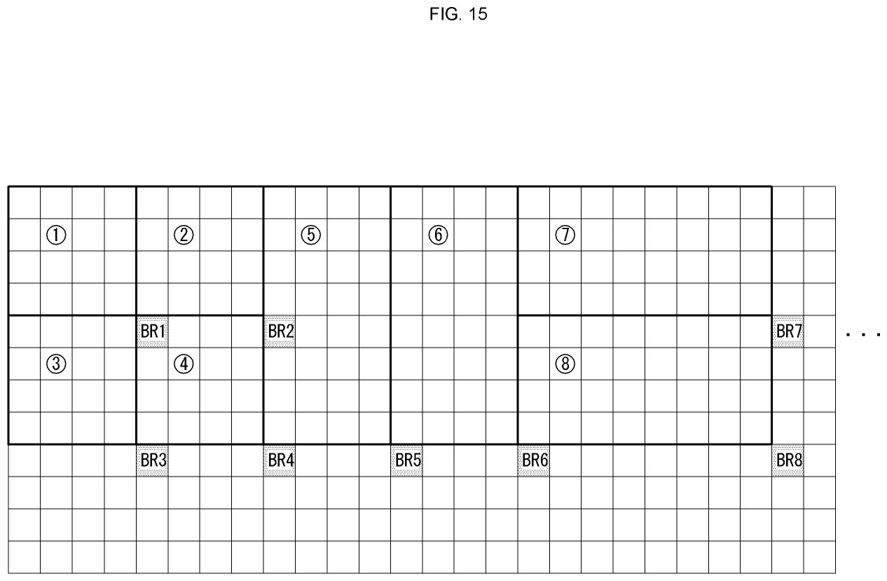

FIG. 15 is a diagram illustrating a method for transmitting a sample value of a bottom right reference sample location of an original image according to an embodiment of the present disclosure.

Referring to FIG. 15, the encoder may transmit to the decoder the difference value between the bottom right reference sample value of the encoded/decoded block immediately before the current block and the sample value of the bottom right reference sample location in the original image. That is, in an embodiment of the present disclosure, the encoder/decoder may use the bottom right reference sample value of the encoded/decoded block before the current block as the prediction value of the bottom right reference sample. The encoder may transmit the different value of the bottom right reference sample in units of block according to an encoding order and the decoder may generate the bottom right reference sample by summing up the prediction value of the generated bottom right reference sample and the difference value received from the encoder.

Blocks represented by thick lines in FIG. 15 indicate encoded/decoded blocks. In addition, it is assumed that encoding/decoding is performed in an order described in each block. First, when a first block (block \textcircled{1}) is encoded, the encoder may use a sample value of a BR1 location of the original image as the bottom right reference sample value in performing the linear interpolation intra prediction. In this case, since there is no bottom right reference sample value used previously, the encoder may transmit to the decoder a difference value (i.e., BR1-128 in the case of 8 bits and BR1-512 in the case of 10 bits) from an intermediate value (e.g., 128 in the case of 8 bits and 512 in the case of 10 bits).

When a second block is encoded, the encoder may use a sample value of a BR2 location of the original image as the bottom right reference sample value in performing the linear interpolation intra prediction. In this case, since there is the block (i.e., first block) which is previously encoded, a different value (i.e., BR2−BR1) from the sample value of the BR2 location of the original image may be transmitted to the decoder by using the bottom right reference sample value of the previously encoded block. In the same method as above, the encoder may transmit to the decoder a difference value between the sample value of the bottom right location of the current block in the original image and the bottom right reference sample value of the previously encoded block in order to signal the bottom right reference sample value of the current block to the decoder.

In an embodiment, the encoder may divide a calculated different value into specific values and transmit the specific values to the decoder in order to save signaling bits. In this case, a shift operation may be applied instead of a division operation for an integer operation. The encoder may convert a different value calculated by using Equation 3 below.

Value_Δ′=(Value_Δ+2^{(div-1)})>>div [Equation 3]

Here, Value_Δ′ represents a converted difference value transmitted to the decoder and Value_Δ represents a difference value acquired through comparison with the original image by the encoder. In addition, div corresponds to a parameter used for converting the difference value. div may be previously set and adaptively changed according to a bit rate environment. In a latter case, the encoder may transmit the div information to the decoder in units of higher levels (e.g., sequence, picture, and slice). In addition, 2^{(div-1)} means an offset determined according to div.

### Embodiment 2-2

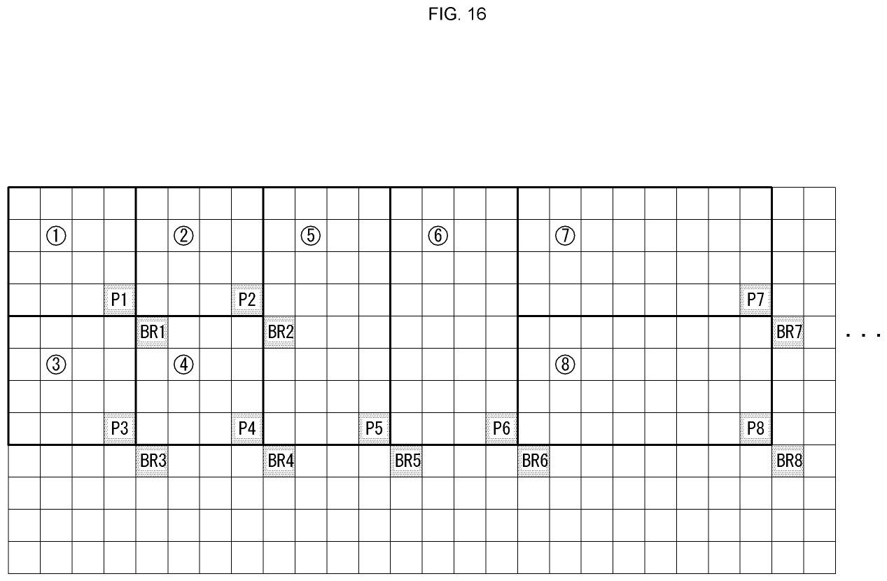

FIG. 16 is a diagram illustrating a method for transmitting a sample value of a bottom right reference sample location of an original image according to an embodiment of the present disclosure.

Referring to FIG. 16, the encoder may transmit to the decoder a difference value between the bottom right prediction sample value in the prediction block generated through the intra prediction and the sample value of the bottom right location of the current block in the original image. That is, in an embodiment of the present disclosure, the encoder/decoder may use the bottom right prediction sample in the prediction block of the current block as the prediction value of the bottom right reference sample. In addition, the encoder may transmit the different value of the bottom right reference sample and the decoder may generate the bottom right reference sample by summing up the prediction value of the generated bottom right reference sample and the difference value received from the encoder.

Blocks represented by thick lines in FIG. 16 indicate encoded/decoded blocks. In addition, it is assumed that encoding/decoding is performed in an order described in each block.

Specifically, when the first block (block \textcircled{1}) is encoded, the encoder may use the sample value of the BR1 location of the original image as the bottom right reference sample value in performing the linear interpolation intra prediction. In this case, the encoder may transmit to the decoder a difference value (BR1−P1) from a bottom right prediction sample value P1 in the prediction block generated according to the prediction mode of the current block.

When the second block is encoded by the same method, the encoder may use a sample value of a BR2 location of the original image as the bottom right reference sample value in performing the linear interpolation intra prediction. In addition, the encoder may transmit to the decoder a difference value (BR2−P2) from a bottom right prediction sample value P2 in the prediction block generated according to the prediction direction.

In an embodiment, the encoder may divide a calculated different value into specific values and transmit the specific values to the decoder in order to save signaling bits. In this case, a shift operation may be applied instead of a division operation for an integer operation. The encoder may convert a different value calculated by using Equation 3 described above.

### Embodiment 2-3

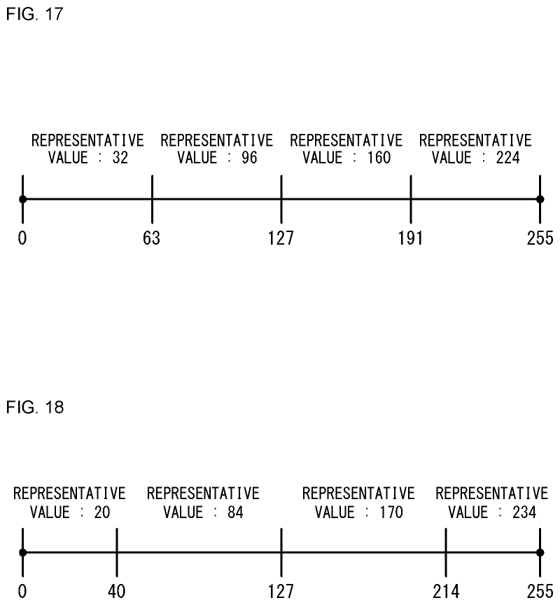

FIGS. 17 and 18 are diagrams illustrating a method for transmitting a sample value of a bottom right reference sample location of an original image according to an embodiment of the present disclosure.

In an embodiment of the present disclosure, the encoder may quantize the sample value and divide the quantized sample value into a specific interval (or area) by considering bits used for expressing each sample value of a current image and then transmit a representative value of an interval including the bottom right reference sample value of the original image to the decoder. In the present disclosure, the representative value may be referred to as a default offset value.

Referring to FIG. 17, it is assumed that bits for expressing each sample value of the image are 8 bits. The encoder may transmit the default offset value indicating the equally divided interval as illustrated in FIG. 17. That is, the encoder may divide a range of sample values 0 to 255 into four intervals and transmit to the decoder an index indicating an interval to which the bottom right reference sample value of the original image belongs. In this case, the encoder may signal to the decoder information on four intervals by using two bits.

For example, 00 bits may be assigned to an index indicating a first interval having a representative value of 32, 01 bits may be assigned to an index indicating a second interval having a representative value of 96, 10 bits may be assigned to an index indicating a third interval having a representative value of 160, and 11 bits may be assigned to an index indicating a fourth interval having a representative value of 224.

In the embodiment, the method is described on the assumption that sample values of 0 to 255 are divided into four intervals, but the present disclosure is not limited thereto and the number of divided intervals may be arbitrarily determined.

Referring to FIG. 18, it is assumed that bits for expressing each sample value of the image are 8 bits. The encoder may transmit a default offset value indicating the unequally divided interval as illustrated in FIG. 18. That is, the encoder may divide a range of sample values 0 to 255 into four intervals and transmit to the decoder an index indicating an interval to which the bottom right reference sample value of the original image belongs. In this case, the encoder may signal to the decoder information on four intervals by using two bits.

For example, 00 bits may be assigned to an index indicating a first interval having a representative value of 20, 01 bits may be assigned to an index indicating a second interval having a representative value of 84, 10 bits may be assigned to an index indicating a third interval having a representative value of 170, and 11 bits may be assigned to an index indicating a fourth interval having a representative value of 234.

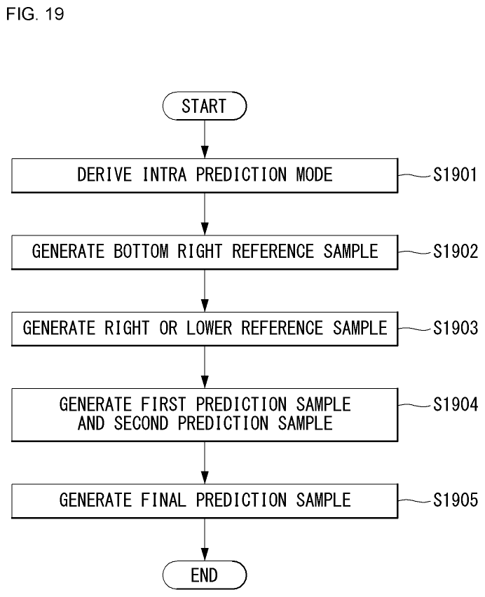

FIG. 19 is a diagram illustrating a linear interpolation prediction method based on an intra prediction mode according to an embodiment of the present disclosure.

Referring to FIG. 19, the encoder/decoder derives the intra prediction mode of the current block (S1901).

The encoder/decoder generates a bottom right reference sample adjacent to the bottom right side of the current block (S1902). The encoder/decoder may generate the bottom right reference sample by applying the methods described in FIGS. 11 to 18 above.

Specifically, as described in FIG. 11 above, the bottom right reference sample may be generated by using the reference sample determined according to the prediction direction of the intra prediction mode.

Further, as described in FIG. 12 above, when the prediction direction of the intra prediction mode belongs to a predetermined area, the bottom right reference sample may be generated by using the reference sample determined according to the prediction direction.

Further, as described in FIG. 13 above, the bottom right reference sample may be generated by using the reference sample determined according to the prediction direction and at least one reconstructed reference sample around the current block.

In an embodiment, the at least one reconstructed reference sample may be determined as a reference sample most adjacent in the horizontal or vertical direction of the bottom right reference sample or a bottom leftmost reference sample or a top rightmost reference sample among reference samples in directions other than the reference sample direction determined according to the prediction direction.

Further, as described in FIG. 15 above, the bottom right reference sample may be generated by summing up the sample value at the bottom right location of the block encoded before the current block and the difference value of the bottom right reference sample received from the encoder.

Further, as described in FIG. 16 above, the bottom right reference sample may be generated by summing up the prediction sample value of the bottom right sample in the current block generated based on the intra prediction mode and the difference value of the bottom right reference sample received from the encoder.

Further, as described in FIGS. 17 and 18 above, the bottom right reference sample may be generated by using the quantized representative value received from the encoder.

The encoder/decoder generates the right reference sample or the bottom reference sample by using the bottom right reference sample (S1903). The encoder/decoder may generate the right reference sample or the bottom reference sample by applying the methods described in FIGS. 7 to 10 above.

The encoder/decoder generates a first prediction sample and a second prediction sample of the current sample in the current block based on the prediction direction of the intra prediction mode (S1904). The encoder/decoder generates the final prediction sample of the current sample by interpolating the first prediction sample and the second prediction sample (S1905). The encoder/decoder generates the first prediction sample and the second prediction sample by applying the methods described in FIGS. 7 and 8 above and interpolates the first prediction sample and the second prediction sample to generate the final prediction sample of the current sample.

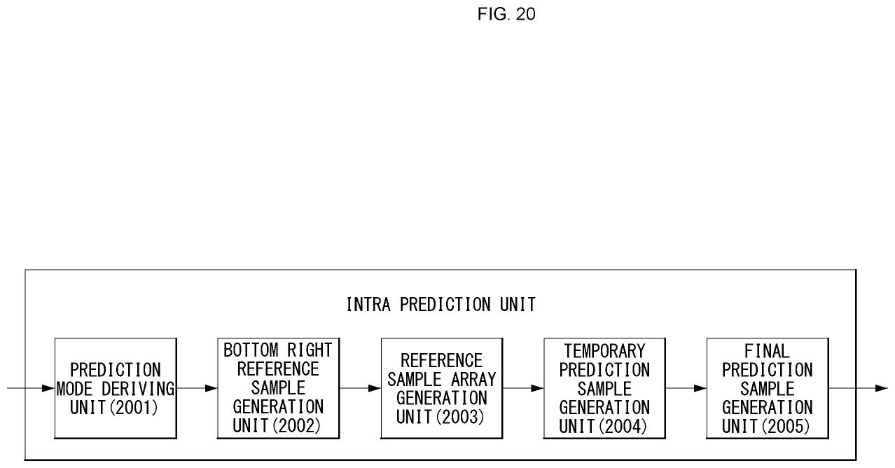

FIG. 20 is a diagram more specifically illustrating an intra prediction unit according to an embodiment of the present disclosure.

In FIG. 20, the intra prediction unit is illustrated as one block for convenience of description, but the intra prediction unit may be implemented in a configuration included in the encoder and/or the decoder.

Referring to FIG. 20, the intra prediction unit implements the functions, procedures, and/or methods proposed in FIGS. 7 to 19 above. Specifically, the intra prediction unit may be configured to include a prediction mode deriving unit 2001, a bottom right reference sample generation unit 2002, a reference sample array generation unit 2003, a temporary prediction block generation unit 2004, and a final prediction block generation unit 2005.

Referring to FIG. 20, the prediction mode deriving unit 2001 derives the intra prediction mode of the current block.

The bottom right reference sample generation unit 2002 generates the bottom right reference sample adjacent to the bottom right side of the current block. The bottom right reference sample generation unit 2002 may generate the bottom right reference sample by applying the methods described in FIGS. 11 to 18 above.

Specifically, as described in FIG. 11 above, the bottom right reference sample may be generated by using the reference sample determined according to the prediction direction of the intra prediction mode.

Further, as described in FIG. 12 above, when the prediction direction of the intra prediction mode belongs to a predetermined area, the bottom right reference sample may be generated by using the reference sample determined according to the prediction direction.

Further, as described in FIG. 13 above, the bottom right reference sample may be generated by using the reference sample determined according to the prediction direction and at least one reconstructed reference sample around the current block.

In an embodiment, the at least one reconstructed reference sample may be determined as a reference sample most adjacent in the horizontal or vertical direction of the bottom right reference sample or a bottom leftmost reference sample or a top rightmost reference sample among reference samples of directions other than the reference sample direction determined according to the prediction direction.

Further, as described in FIG. 15 above, the bottom right reference sample may be generated by summing up the sample value at the bottom right location of the block encoded before the current block and the difference value of the bottom right reference sample received from the encoder.

Further, as described in FIG. 16 above, the bottom right reference sample may be generated by summing up the prediction sample value of the bottom right sample in the current block generated based on the intra prediction mode and the difference value of the bottom right reference sample received from the encoder.

Further, as described in FIGS. 17 and 18 above, the bottom right reference sample may be generated by using the quantized representative value received from the encoder.

The reference sample array generation unit 2003 generates the right reference sample or the bottom reference sample by using the bottom right reference sample. The reference sample array generation unit 2003 may generate the right reference sample or the bottom reference sample by applying the methods described in FIGS. 7 to 10 above.

The temporary prediction block generation unit 2004 generates the first prediction sample and the second prediction sample of the current sample in the current block based on the prediction direction of the intra prediction mode. In the present disclosure, the first prediction sample and the second prediction sample may be collectively referred to as a temporary prediction sample. The final prediction block generation unit 2005 generates the final prediction sample of the current sample by interpolating the first prediction sample and the second prediction sample. The encoder/decoder generates the first prediction sample and the second prediction sample by applying the methods described in FIGS. 7 and 8 above and interpolates the first prediction sample and the second prediction sample to generate the final prediction sample of the current sample.

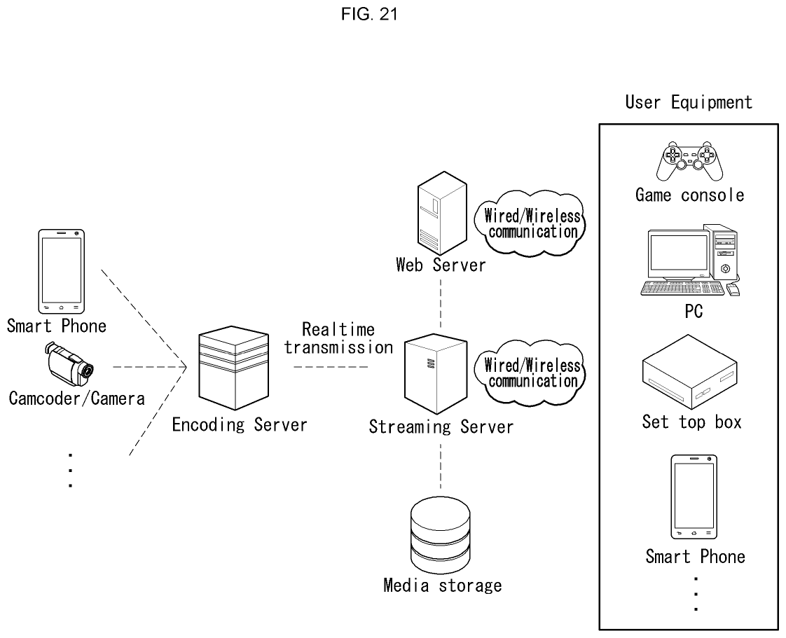

FIG. 21 is a structural diagram of a content streaming system as an embodiment to which the present disclosure is applied.

Referring to FIG. 21, the content streaming system to which the present disclosure is applied may largely include an encoding server, a streaming server, a web server, a media storage, a user device, and a multimedia input device.

The encoding server compresses contents input from multimedia input devices including a smartphone, a camera, a camcorder, etc., into digital data to serve to generate the bitstream and transmit the bitstream to the streaming server. As another example, when the multimedia input devices including the smartphone, the camera, the camcorder, etc., directly generate the bitstream, the encoding server may be omitted.

The bitstream may be generated by the encoding method or the bitstream generating method to which the present disclosure is applied and the streaming server may temporarily store the bitstream in the process of transmitting or receiving the bitstream.

The streaming server transmits multimedia data to the user device based on a user request through a web server, and the web server serves as an intermediary for informing a user of what service there is. When the user requests a desired service to the web server, the web server transfers the requested service to the streaming server and the streaming server transmits the multimedia data to the user. In this case, the content streaming system may include a separate control server and in this case, the control server serves to control a command/response between respective devices in the content streaming system.

The streaming server may receive contents from the media storage and/or the encoding server. For example, when the streaming server receives the contents from the encoding server, the streaming server may receive the contents in real time. In this case, the streaming server may store the bitstream for a predetermined time in order to provide a smooth streaming service.

Examples of the user device may include a cellular phone, a smart phone, a laptop computer, a digital broadcasting terminal, a personal digital assistants (PDA), a portable multimedia player (PMP), a navigation, a slate PC, a tablet PC, an ultrabook, a wearable device such as a smartwatch, a smart glass, or a head mounted display (HMD), etc., and the like.

Each server in the content streaming system may be operated as a distributed server and in this case, data received by each server may be distributed and processed.

As described above, the embodiments described in the present disclosure may be implemented and performed on a processor, a microprocessor, a controller, or a chip. For example, functional units illustrated in each drawing may be implemented and performed on a computer, the processor, the microprocessor, the controller, or the chip.

In addition, the decoder and the encoder to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an (Over the top) OTT video device, an Internet streaming service providing devices, a 3 dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the Over the top (OTT) video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

In the aforementioned embodiments, the elements and characteristics of the present disclosure have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present disclosure. The order of the operations described in connection with the embodiments of the present disclosure may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present disclosure may be implemented by various means, for example, hardware, firmware, software or a combination of them. In the case of implementations by hardware, an embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present disclosure may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present disclosure may be materialized in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### INDUSTRIAL APPLICABILITY

The aforementioned preferred embodiments of the present disclosure have been disclosed for illustrative purposes, and those skilled in the art may improve, change, substitute, or add various other embodiments without departing from the technological spirit and scope of the present disclosure disclosed in the attached claims.

1. A method for processing an image based on an intra prediction mode, comprising:
deriving an intra prediction mode of a current block;
generating a bottom right reference sample adjacent to a bottom right side of the current block;
generating a right reference sample or a lower reference sample by using the bottom right reference sample
generating a first prediction sample and a second prediction sample of the current sample in the current block based on a prediction direction of the intra prediction mode; and
generating a final prediction sample of the current sample by interpolating the first prediction sample and the second prediction sample.

2. The method of claim 1,
wherein the bottom right reference sample is generated by using a reference sample determined according to the prediction direction of the intra prediction mode.

3. The method of claim 1,
wherein, if the prediction direction of the intra prediction mode belongs to a predetermined region, the bottom right reference sample is generated by using a reference sample determined according to the prediction direction.

4. The method of claim 1,
wherein the bottom right reference sample is generated by using a reference sample determined according to the prediction direction and at least one reconstructed reference sample adjacent to the current block.

5. The method of claim 4,
wherein the at least one reconstructed reference sample is determined as the closest reference sample in horizontal or vertical direction of the bottom right reference sample, or the most left-bottom reference sample or the most right-above reference sample among reference samples other than reference sample direction determined according to the prediction direction.

6. The method of claim 1,
wherein the bottom right reference sample is generated by adding a sample value of bottom right location of a previously encoded block of the current block and a difference value of the bottom right reference sample received from an encoder.

7. The method of claim 1,
wherein the bottom right reference sample is generated by adding a prediction sample value of a bottom right sample of the current block generated based on the intra prediction mode and a difference value of the bottom right reference sample received from an encoder.

8. The method of claim 1,
wherein the bottom right reference sample is generated by using a quantized representative value received from an encoder.

9. An apparatus for processing an image based on an intra prediction mode, comprising:
a prediction mode derivation unit for deriving an intra prediction mode of a current block;
a bottom right reference sample generation unit for generating a bottom right reference sample adjacent to a bottom right side of the current block;
a reference sample array generation unit for generating a first prediction sample and a second prediction sample of the current sample in the current block based on a prediction direction of the intra prediction mode
a temporary prediction sample generation unit for generating a first prediction sample and a second prediction sample of a current sample in the current block based on prediction direction of the intra prediction mode; and
a final prediction sample generation unit for generating a final prediction sample of the current sample by interpolating the first prediction sample and the second prediction sample.
